(19) United States
(12) Patent Application Publication
(10) Pub. No.: US 2021/0225212 A1
(43) Pub. Date: Jul. 22, 2021

(54) TILED TRANSPARENT DISPLAY DEVICE AND TRANSPARENT DISPLAY DEVICE FOR TILING

(71) Applicant: Innolux Corporation, Miao-Li County (TW)

(72) Inventors: Jui-Jen Yueh, Miao-Li County (TW); Kuan-Feng Lee, Miao-Li County (TW)

(73) Assignee: Innolux Corporation, Miao-Li County (TW)

(21) Appl. No.: 17/133,579

(22) Filed: Dec. 23, 2020

(30) Foreign Application Priority Data
Jan. 17, 2020 (CN) 202010052675.6

(51) Int. Cl. G09F 9/302; G09F 9/33; G06F 3/14

(52) U.S. Cl. CPC G09F 9/3026; G06F 3/1446; G09F 9/33

(57) ABSTRACT

The disclosure provides a tiled transparent display device and a transparent display device for tiling. The tiled transparent display device includes a first transparent display panel, a second transparent display panel, and a coupling member. The second transparent display panel is adjacent to the first transparent display panel.

The coupling member is disposed between the first transparent display panel and the second transparent display panel. A reflectance (R_{c}) of the coupling member, a transmittance (Tₚ₁) of the first transparent display panel, and a transmittance (Tₚ₂) of the second transparent display panel satisfy the following relationship: 0.8 Tₚ₁≤R_{c}≤1.2 Tₚ₁, and 0.8 Tₚ₂≤R_{c}≤1.2 Tₚ₂.

### CROSS-REFERENCE TO RELATED APPLICATION

This application claims the priority benefit of China application serial no. 202010052675.6, filed on Jan. 17, 2020. The entirety of the above-mentioned patent application is hereby incorporated by reference herein and made a part of this specification.

### BACKGROUND

### Field of the Disclosure

The disclosure relates to a tiled transparent display device and a transparent display device for tiling.

### Description of Related Art

With the development of video techniques, electronic devices (such as display devices) may be spliced into the electronic devices of different sizes (such as outdoor billboards for displaying images) as needed. Therefore, the improvement of the quality of tiled electronic devices has been one of the vigorously developed techniques in recent years.

### SUMMARY

According to an embodiment of the disclosure, a tiled transparent display device includes a first transparent display panel, a second transparent display panel, and a coupling member. The second transparent display panel is adjacent to the first transparent display panel. The coupling member is disposed between the first transparent display panel and the second transparent display panel. A reflectance (R_{c}) of the coupling member, a transmittance (Tₚ₁) of the first transparent display panel, and a transmittance (Tₚ₂) of the second transparent display panel satisfy the following relationship: 0.8 Tₚ₁≤R_{c}≤1.2 Tₚ₁, and 0.8 Tₚ₂≤R_{c}≤1.2 Tₚ₂.

According to an embodiment of the disclosure, a transparent display device for tiling includes a transparent display panel and a coupling member. The coupling member is disposed on at least one side of the transparent display panel. A reflectance (R_{c}) of the coupling member and a transmittance (Tₚ) of the transparent display panel satisfy the following relationship: 0.8 Tₚ≤R_{c}≤1.2 Tₚ.

### BRIEF DESCRIPTION OF THE DRAWINGS

The accompanying drawings are included to further understand the disclosure, and the drawings are incorporated in the specification and constitute a part of the specification. The drawings illustrate embodiments of the disclosure and, together with the description, serve to explain principles of the disclosure.

FIG. 1 is a top view of a tiled transparent display device according to an embodiment of the disclosure.

FIG. 2 is a cross-sectional view of the first embodiment according to section line A-A′ of FIG. 1.

FIG. 3 is a cross-sectional view of the second embodiment according to section line A-A′ of FIG. 1.

FIG. 4 is a cross-sectional view of the third embodiment according to section line A-A′ of FIG. 1.

FIG. 5 is a cross-sectional view of the fourth embodiment according to section line A-A′ of FIG. 1.

FIG. 6 is a cross-sectional view of the fifth embodiment according to section line A-A′ of FIG. 1.

FIG. 7 is a cross-sectional view of the sixth embodiment according to section line A-A′ of FIG. 1.

FIG. 8 is a cross-sectional view of the seventh embodiment according to section line A-A′ of FIG. 1.

FIG. 9 is a diagram of a part of a manufacturing process of a tiled transparent display device of an embodiment of the disclosure.

FIG. 10 is a diagram of a part of a manufacturing process of a tiled transparent display device of another embodiment of the disclosure.

### DESCRIPTION OF THE EMBODIMENTS

The disclosure may be understood by referring to the following detailed description in conjunction with the accompanying drawings. It should be noted that in order to facilitate understanding to the reader and to simplify the drawings, the multiple drawings in the disclosure depict a part of the electronic device, and certain elements in the drawings are not drawn to actual scale. In addition, the number and size of each element in the figures are for illustration, and are not intended to limit the scope of the disclosure.

Certain terms are used throughout the specification and the appended claims of the disclosure to refer to particular elements. Those skilled in the art should understand that electronic device manufacturers may refer to the same elements under different names. This specification is not intended to distinguish between elements having the same function but different names. In the following description and claims, the words “including”, “containing”, “having” and the like are open words, so they should be interpreted as meaning “including but not limited to . . . ” Therefore, when the terms “including”, “containing”, and/or “having” are used in the description of the disclosure, they specify the presence of corresponding features, regions, steps, operations, and/or components, but do not exclude the presence of one or more corresponding features, regions, steps, operations, and/or components.

The terminology mentioned in the specification, such as: “up”, “down”, “front”, “rear”, “left”, “right”, etc., are directions referencing the drawings. Therefore, the directional terms used are for illustration and not to limit the disclosure. In the drawings, each drawing depicts general features of methods, structures, and/or materials used in specific embodiments. However, these drawings should not be construed to define or limit the scope or nature covered by these embodiments. For example, for clarity, the relative size, thickness, and position of each film, region, and/or structure may be reduced or enlarged.

When a corresponding component (such as a film or region) is referred to as “on another component”, it may be directly on the other component, or there may be other components between the two. Moreover, when a component is referred to as “directly on another component”, there is no component between the two. In addition, when a component is referred to as “on another component”, the two components have an up-down relationship in the top view, and this component may be above or below the other component, and this up-down relationship depends on the orientation of the device.

The terms “about”, “equal to”, “equal” or “identical”, “substantially” or “roughly” are generally interpreted as being within 20% of a given value or range, or interpreted as being within 10%, 5%, 3%, 2%, 1%, or 0.5% of a given value or range.

The ordinals used in the specification and claims, such as “first”, “second”, etc., are used to modify an element. They do not themselves imply and represent that the element(s) have any previous ordinal, and also do not represent the order of one element and another element, or the order of manufacturing methods. The use of these ordinals is to clearly distinguish an element with a certain name from another element with the same name. The same terms may not be used in the claims and the specification, and accordingly, the first component in the specification may be the second component in the claims.

It should be noted that in the following embodiments, the features in several different embodiments may be replaced, recombined, and mixed to complete other embodiments without departing from the spirit of the disclosure. As long as the features between the embodiments do not violate the spirit of the disclosure or conflict with one another, they may be mixed and used arbitrarily.

The electrical connection or coupling described in the present disclosure may refer to direct connection or indirect connection. In the case of direct connection, the endpoints of the elements on two circuits are directly connected or connected to each other by a conductive line segment. In the case of indirect connection, there are switches, diodes, capacitors, inductors, other suitable elements, or a combination of the elements between the endpoints of the elements on the two circuits, but the disclosure is not limited thereto.

In the present disclosure, the thickness, length, and width may be measured using an optical microscope, and the thickness may be measured from a cross-sectional image in an electron microscope, but the disclosure is not limited thereto. In addition, there may be a certain error in any two values or directions for comparison. If the first value is equal to the second value, it implies that there may be an error of about 10% between the first value and the second value. If the first direction is perpendicular to the second direction, the angle between the first direction and the second direction may be between 80 degrees and 100 degrees. If the first direction is parallel to the second direction, the angle between the first direction and the second direction may be between 0 degrees and 10 degrees.

The electronic device of the disclosure may include a display, an antenna (such as a liquid crystal antenna), light-emitting, sensing, touch, tiled, other suitable functions, or a combination of the functions, but the disclosure is not limited thereto. The electronic device includes, but is not limited to, a rollable or flexible electronic device. The electronic device may include, for example, a liquid crystal, a light-emitting diode (LED), a quantum dot (QD), fluorescence, phosphor, other suitable materials, or a combination of the above. The light-emitting diode may include, for example, an organic light-emitting diode (OLED), a micro light-emitting diode (micro LED, mini LED), or a quantum dot light-emitting diode (QLED, QDLED), but the disclosure is not limited thereto. The content of the disclosure is explained in the following using a display device or a tiled device as an electronic device, but the disclosure is not limited thereto.

The following exemplifies the exemplary embodiments of the disclosure. The same reference numerals are used in the drawings and description to represent the same or similar parts.

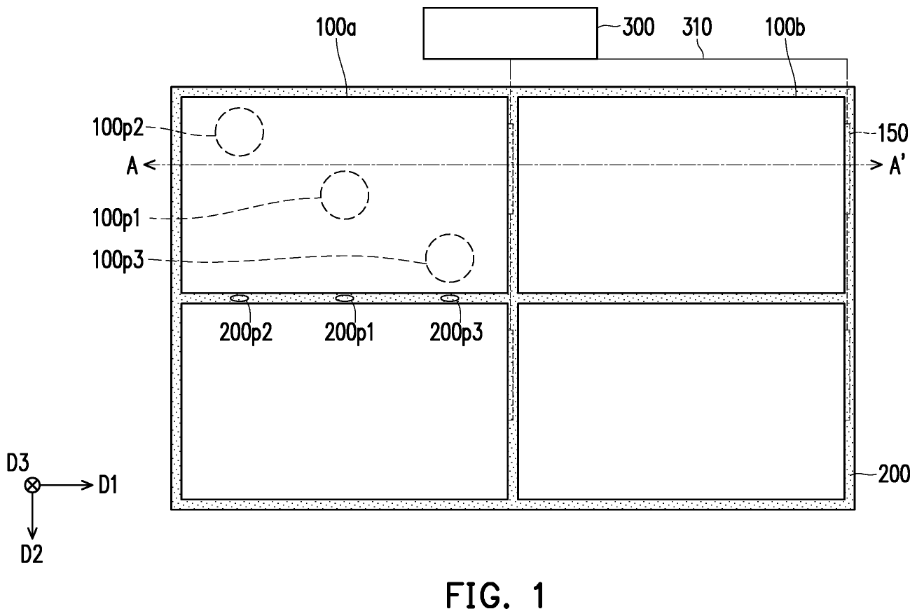

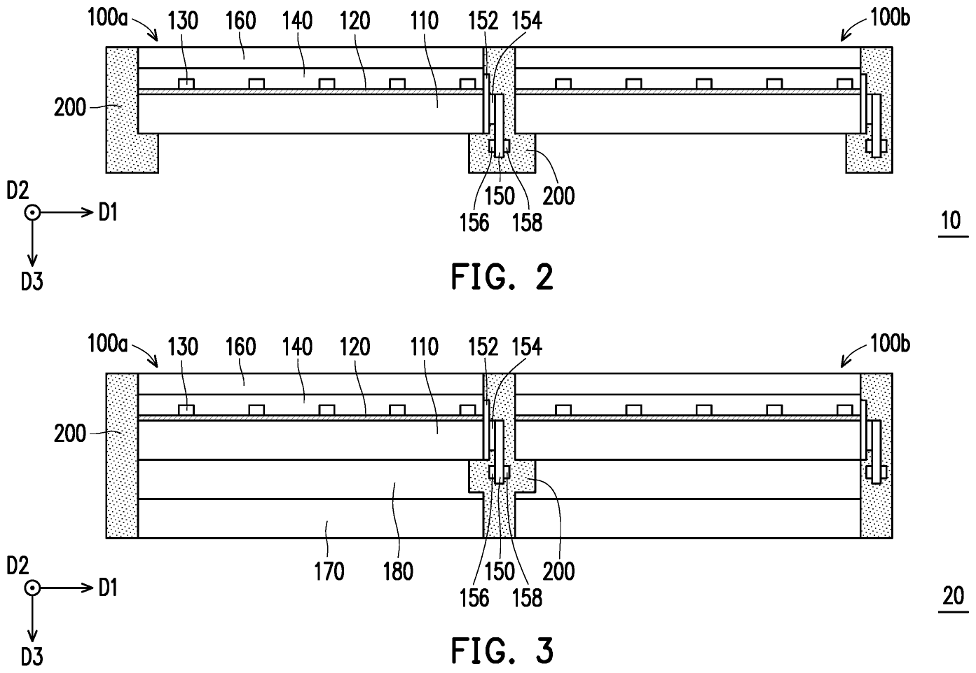

FIG. 1 is a top view of a tiled transparent display device of an embodiment of the disclosure. FIG. 2 is a cross-sectional view of the first embodiment according to section line A-A′ of FIG. 1. For clarity and convenience of illustration, FIG. 1 omits some elements.

Referring to FIG. 1 and FIG. 2, a tiled transparent display device 10 includes a first transparent display panel 100a, a second transparent display panel 100b and a coupling member 200. The coupling member 200 may be disposed between the first transparent display panel 100a and the second transparent display panel 100b. The second transparent display panel 100b is adjacent to the first transparent display panel 100a. For example, the second transparent display panel 100b is adjacent to one side surface of the first transparent display panel 100a, the first transparent display panel 100a and the second transparent display panel 100b may be sequentially arranged in a first direction D1 and/or a second direction D2, and the first direction D1 is different from the second direction D2, but it is not limited thereto. In some embodiments, the first direction D1 and the second direction D2 are orthogonal to each other, but are not limited thereto. In the present embodiment, the shape of the first transparent display panel 100a and/or the shape of the second transparent display panel 100b may be rectangular, but it is not limited thereto. In other embodiments, the shape of the first transparent display panel 100a and/or the shape of the second transparent display panel 100b may include a circle, a polygon, an arc, or other suitable shapes, but it is not limited thereto. In addition, the first transparent display panel 100a and/or the second transparent display panel 100b may be a color display or a monochrome display.

Referring to FIG. 1 and FIG. 2, the tiled transparent display device 10 may further include a control unit 300 and a plurality of signal transmission lines 310. In some embodiments, the control unit 300 includes a control circuit or other suitable electronic components. The signal transmission lines 310 may be used to electrically connect the control unit 300 with the first transparent display panel 100a and/or the second transparent display panel 100b, but it is not limited thereto. In some embodiments, the control unit 300 may transmit signals to the first transparent display panel 100a and/or the second transparent display panel 100b through the signal transmission lines 310, the first transparent display panel 100a and the second transparent display panel 100b may perform actions (such as display) based on the received signal. It should be noted that the first transparent display panel 100a and/or the second transparent display panel 100b may include a transparent substrate 110, an element layer 120, a plurality of light-emitting elements 130, an insulating layer 140, and/or a circuit board 150, but it is not limited thereto. In some embodiments, the material of the transparent substrate 110 may include glass, plastic, ceramic, quartz, sapphire, or a combination thereof. For example, the material of the transparent substrate 110 may include polymethyl methacrylate (PMMA), polycarbonate (PC), polyimide (PI), polyethylene terephthalate (PET), or other suitable materials or a combination of the above materials, but it is not limited thereto.

Referring to FIG. 1 and FIG. 2, the element layer 120 may be disposed on the transparent substrate 110. In some embodiments, the element layer 120 includes a circuit structure for driving the plurality of light-emitting elements 130. For example, the element layer 120 may include a plurality of scan lines, a plurality of data lines, a plurality of transistors, a plurality of signal lines, and/or a plurality of electrodes, but it is not limited thereto. In some embodiments, the plurality of light-emitting elements 130 may be disposed on the element layer 120, the plurality of light-emitting elements 130 may be disposed on the element layer 120 in an array arrangement, staggered arrangement (for example, in a pentile manner), or other manners, but it is not limited thereto. In some embodiments, the plurality of light-emitting elements 130 may be electrically connected to the element layer 120 through a conductive pad (not shown), but the disclosure is not limited thereto. In some embodiments, the light-emitting elements 130 may include an organic light-emitting diode (OLED), an inorganic light-emitting diode (LED), such as a micro light-emitting diode (micro LED, mini LED), a quantum dot (QD), or a quantum dot light-emitting diode (QLED, QDLED), fluorescence, phosphor, other suitable materials or a combination of the above materials, but it is not limited thereto. In other embodiments, the light-emitting elements 130 may include a non-self-light-emitting material, such as liquid crystal or other suitable media, but it is not limited thereto.

Referring to FIG. 1 and FIG. 2, in some embodiments, the insulating layer 140 may be disposed on the element layer 120 and/or covers the plurality of light-emitting elements 130, and the insulating layer 140 may be used for fixing or protecting the plurality of light-emitting elements 130. In some embodiments, the insulating layer 140 includes a transparent material or a protective material, such as epoxy resin, acrylic, other suitable materials or a combination thereof, but it is not limited thereto. In some embodiments, the insulating layer 140 may include a single layer structure or a composite layer structure. In some embodiments, the circuit board 150 is disposed on at least one side surface of the first transparent display panel 100a, for example, and the circuit board 150 may be electrically connected to the element layer 120 through a conductive element 152. For example, the circuit board 150 may be disposed on a side surface (such as a side surface of the transparent substrate 110) of the first transparent display panel 100a adjacent to the second transparent display panel 100b, and the circuit board 150 may be disposed between the first transparent display panel 100a and the second transparent display panel 100b, but it is not limited thereto. In some embodiments, the circuit board 150 may be extended toward a third direction D3, the third direction D3 is the normal direction of the first transparent substrate 110, and the third direction D3 is perpendicular to the first direction D1 and/or the second direction D2. In some embodiments, the circuit board 150 may optionally exceed the transparent substrate 110 (for example, the surface of the transparent substrate 110 away from the element layer 120), but the disclosure is not limited thereto. In some embodiments, the conductive element 152 is disposed between the first transparent display panel 100a and the circuit board 150, for example. In some embodiments, the conductive element 152 is disposed on a side surface of the first transparent display panel 100a (e.g., a side surface of the transparent substrate 110). In some embodiments, the conductive element 152 is connected between the element layer 120 and the circuit board 150 to electrically connect the element layer 120 and the circuit board 150. In some embodiments, the conductive element 152 may be electrically connected to the circuit board 150 through a conductive adhesive 154. In some embodiments, the material of the conductive adhesive 154 may include anisotropic conductive film (ACF), conductive silver adhesive, other suitable materials or a combination of the above materials, but it is not limited thereto. In some embodiments, the circuit board 150 may include a rigid circuit board or a flexible circuit board, such as a flexible printed circuit board (FPC), but it is not limited thereto. In the present embodiment, the first transparent display panel 100a further includes a chip 156 (for example, a driving chip), but it is not limited thereto. The chip 156 is, for example, disposed on the circuit board 150 and is electrically connected to the circuit board 150, but it is not limited thereto. In some embodiments, the chip 156 of the circuit board 150 may control the light-emitting elements 130 through the conductive element 152 and the element layer 120. In other embodiments, the element layer 120 may include a driving circuit. The driving circuit is, for example, in a chip-on-plastic (COP) or chip-on-glass (COG) manner, but it is not limited thereto. In some embodiments, the circuit board 150 may include other electronic components, such as a connector 158, but it is not limited thereto. In some embodiments, the connector 158 may electrically connect the circuit board 150 to another circuit board through the signal transmission lines 310, or may electrically connect the circuit board 150 to the control unit 300 through the signal transmission lines 310, but it is not limited thereto. In other embodiments, the connector 158 may be changed to a transmitting and receiving terminal for wireless transmission, and the signal transmission lines 310 may be optionally removed at this time.

Referring to FIG. 2, in some embodiments, the first transparent display panel 100a may further include a functional layer 160. In some embodiments, the functional layer 160 may include a material having high hardness characteristics. For example, the functional layer 160 may include a coating (not shown) with a pencil hardness greater than 5H or other suitable materials, but it is not limited thereto. The functional layer 160 may be used as a protective layer. In some embodiments, the functional layer 160 may include a single layer or a composite material. In some embodiments, the functional layer 160 may include a material of an anti-glare or optical matching layer. The optical matching layer may include a plurality of layers having different refractive indices to reduce the issue that the element layer 120 interferes with the display image of the first transparent display panel 100a under the irradiation of ambient light.

It should be noted that the structure and/or components of the second transparent display panel 100b are substantially similar to those of the first transparent display panel 100a. When the second transparent display panel 100b and the first transparent display panel 100a use the same or similar structures and/or components, the same or similar reference numerals are used, which are not repeated herein.

Referring to FIG. 2, in some embodiments, a coupling member 200 is disposed between the first transparent display panel 100a and the second transparent display panel 100b, for example. In some embodiments, the coupling member 200 may be in contact with or cover the circuit board 150, the conductive element 152, the chip 156, and/or the connector 158 for protecting the circuit board 150, the conductive element 152, the chip 156, and/or the connector 158, but it is not limited thereto. In some embodiments, the coupling member 200 may be in contact with the first transparent display panel 100a and the second transparent display panel 100b, and the coupling member 200 may be used as an attachment or buffer between the first transparent display panel 100a and the second transparent display panel 100b, but it is not limited thereto. In some embodiments, the coupling member 200 may include a single layer structure or a multi layer structure. In some embodiments, the material of the coupling member 200 includes a resin (e.g., acrylic resin, epoxy resin, silicon resin), wherein the resin may have a color or the resin may have pigment particles (e.g., carbon black) or dye particles, but it is not limited thereto.

In some embodiments, the transmittance of the coupling member 200 may be greater than 0 and less than 0.1 (0<transmittance<0.1), thereby making the circuit board 150 or other electronic components less observable to a viewer. In addition, when there is a difference between the reflectance of the coupling member 200 and the transmittance of the first transparent display panel 100a and/or the second transparent display panel 100b, a tiled stitching pattern may be generated between the first transparent display panel 100a and the second transparent display panel 100b, such that the picture is discontinuous, thus affecting display quality. Accordingly, in some embodiments, the reflectance (R_{c}) of the coupling member 200, the transmittance (Tₚ₁) of the first transparent display panel 100a, and the transmittance (Tₚ₂) of the second transparent display panel 100b satisfy the following relationship: 0.8 Tₚ₁≤R_{c}<1.2 Tₚ₁, and 0.8 Tₚ₂<R_{c}≤1.2 Tₚ₂. In some embodiments, the reflectance (R_{c}) of the coupling member 200, the transmittance (Tₚ₁) of the first transparent display panel 100a, and the transmittance (Tₚ₂) of the second transparent display panel 100b satisfy the following relationship: 0.95 Tₚ₁≤R_{c}≤105 Tₚ₁, and 0.95 Tₚ₂≤R_{c}≤1.05 Tₚ₂. In the case in which the reflectance (R_{c}) of the coupling member 200, the transmittance (Tₚ₁) of the first transparent display panel 100a, and the transmittance (Tₚ₂) of the second transparent display panel 100b satisfy the above relationship, the presence of the tiled stitching pattern (or the coupling member 200) of the tiled transparent display device 10 may be less observable to a viewer to improve display quality. In some embodiments, the coupling member 200 may be optionally disposed on the side surface of the first transparent display panel 100a (and/or the second transparent display panel 100b) on which the circuit board 150 is not provided, but it is not limited thereto. In some embodiments, the coupling member 200 may optionally be in contact with the bottom surface of the transparent substrate 110. In other embodiments (not shown), a portion of the coupling member 200 disposed on the side surface of the first transparent display panel 100a (and/or the second transparent display panel 100b) may be optionally replaced with other protective structures or light-shielding structures, but the disclosure is not limited thereto.

The measurement methods of the transmittance (Tₚ₁) of the first transparent display panel 100a, the transmittance (Tₚ₂) of the second transparent display panel 100b, the reflectance (R_{c}) of the coupling member 200, and/or the transmittance of the coupling member 200 are described below, but it should be noted that there are one of many measurement methods, and the disclosure is not limited thereto.

The transmittance of the first transparent display panel 100a and/or the transmittance of the second transparent display panel 100b may be measured by a light detection device (such as a spectrophotometer) or other suitable instruments, but the disclosure is not limited thereto. It should be noted that, the transmittance of the first transparent display panel 100a and/or the second transparent display panel 100b may be measured in an OFF-state (e.g., a substantially transparent state). In the following, the measurement method of the transmittance of the first transparent display panel 100a is used as an example. Please refer to FIG. 1 and FIG. 2 at the same time. A light is provided. The light is irradiated from the bottom surface of the first transparent display panel 100a and passes through the top surface (such as the display surface) of the first transparent display panel 100a, and the light passing through may be detected and measured by a light detection device (not shown) or other suitable instruments to obtain the transmittance (Tₚ₁) of the first transparent display panel 100a. In particular, the light may include white light or light of other colors, but it is not limited thereto. In some embodiments, the light may be light with higher collimation, such as infrared light or other suitable light, but it is not limited thereto. In addition, the transmittance (Tₚ₁) of the first transparent display panel 100a may be obtained by measuring the transmittance of a plurality of portions of the first transparent display panel 100a and then taking the average. For example, the transmittance (Tₚ₁) of the first transparent display panel 100a may be obtained by measuring the transmittance of a portion 100p1, the transmittance of a portion 100p2, and/or the transmittance of a portion 100p3 of the first transparent display panel 100a and taking the average of the transmittance of the portions, but it is not limited thereto. It should be noted that the disclosure does not limit the light irradiation direction, measurement position (such as the portion 100p1, the portion 100p2, and/or the portion 100p3), and/or measurement quantity mentioned above, and the light irradiation direction, measurement position, and/or measurement quantity may be adjusted as needed. In other embodiments, the irradiation direction of the light is irradiated from the top surface of the first transparent display panel 100a and passes through the bottom surface of the first transparent display panel 100a, and the transmittance of the first transparent display panel 100a may be obtained by measuring the light passing through a light detection device. Similarly, the transmittance (Tₚ₂) of the second transparent display panel 100b is also measured using the above method, and details are not repeated herein. It should be noted that the transmittance of the second transparent display panel 100b and the transmittance of the first transparent display panel 100a are measured in the same or similar measurement methods, such as the irradiation direction, measurement position, measurement quantity, type of light, etc., but the disclosure is not limited thereto. In addition, the reflectance of the coupling member 200 may be measured by a light detection device (such as a spectrophotometer) or other suitable instruments. For example, referring to FIG. 1 and FIG. 2, light may be incident on the top surface (i.e., the display surface) of the coupling member 200 (e.g., a portion 200p1) and then reflected, and then the reflectance of the coupling member 200 (e.g., the portion 200p1) is obtained through a light detection device. Similarly, the reflectance of the portion 200p2 and the reflectance of the portion 200p3 of the coupling member 200 are also calculated through the above steps, and the reflectance of the portion 200p1, the reflectance of the portion 200p2, and the reflectance of the portion 200p3 are averaged to obtain the reflectance (R_{c}) of the coupling member 200. It should be noted that the measurement position and measurement quantity of the portions (such as the portion 200p1, the portion 200p2, and the portion 200p3) of the coupling member 200 are not limited in the disclosure, and the light, the measurement position, and/or the measurement quantity may be adjusted as needed. Similarly, the transmittance (T_{c}) of the coupling member 200 may be measured in a manner similar to the transmittance of the first transparent display panel 100a and/or the second transparent display panel 100b, such as measuring the transmittance of the portion 200p1, the portion 200p2, and/or the portion 200p3 of the coupling member 200 and taking the average.

It should be noted that in the steps of measuring the transmittance of the first transparent display panel 100a, the transmittance of the second transparent display panel 100b, the reflectance of the coupling member 200, and the transmittance of the coupling member 200, the light used is the same such that the measured data is accurate.

The cross-sectional diagrams of other embodiments are exemplified below. It should be noted that, in the following embodiments, the reference numerals and parts of the content of the embodiment of FIG. 2 may be adopted. The same or similar reference numerals are used to indicate the same or similar components, and the description of the same technical content is omitted.

Referring to FIG. 3, FIG. 3 is a cross-sectional view of the second embodiment according to section line A-A′ of FIG. 1. The difference between a tiled transparent display device 20 and the tiled transparent display device 10 is that the first transparent display panel 100a and/or the second transparent display panel 100b may include a transparent support substrate 170 and/or an adhesive layer 180, but it is not limited thereto. In some embodiments, the transparent support substrate 170 may be disposed on a surface of a side of the transparent substrate 110 away from the display surface (or away from the element layer 120), and the adhesive layer 180 may be disposed between the transparent support substrate 170 and the transparent substrate 110, but it is not limited thereto. In some embodiments, the material of the transparent support substrate 170 and the material of the transparent substrate 110 may be the same or different, and details are not repeated herein. In some embodiments, the thickness of the transparent support substrate 170 may be greater than or equal to the thickness of the transparent substrate 110, and the thickness of the transparent support substrate 170 and the thickness of the transparent substrate 110 may be obtained by measuring the maximum thickness of the substrate in the third direction D3. The adhesive layer 180 may be used to adhere the transparent support substrate 170 and the transparent substrate 110. In some embodiments, the material of the adhesive layer 180 may include a material having a light transmittance greater than or equal to 90% (≥90%), such as a material having a light transmittance between 95% and 99% (95%≤light transmittance≤99%) or between 90% and 95% (90%≤light transmittance≤95%), but it is not limited thereto. In some embodiments, the material of the adhesive layer 180 may include an optical clear resin (OCR) or optical clear adhesive (OCA), for example, including acrylic resin, silicone resin, epoxy resin or other suitable materials or a combination of the above materials, but the disclosure is not limited thereto. In some embodiments, the circuit board 150 may be not extended to the transparent support substrate 170. That is, the circuit board 150 may be not disposed between adjacent transparent support substrates 170, but the disclosure is not limited thereto. In some embodiments, in the first direction D1, the coupling member 200 may be located between adjacent transparent support substrates 170, adjacent transparent substrates 110, and/or adjacent adhesive layers 180. In some embodiments, the material of the adhesive layer 180 is the same as or different from the material of the coupling member 200. In some embodiments, the angle between the top surface (or the bottom surface) and the side surface of the transparent support substrate 170 and/or the transparent substrate 110 may be adjusted according to requirements. In other embodiments, the side surfaces of the transparent support substrate 170 and/or the transparent substrate 110 may be edged, but the disclosure is not limited thereto.

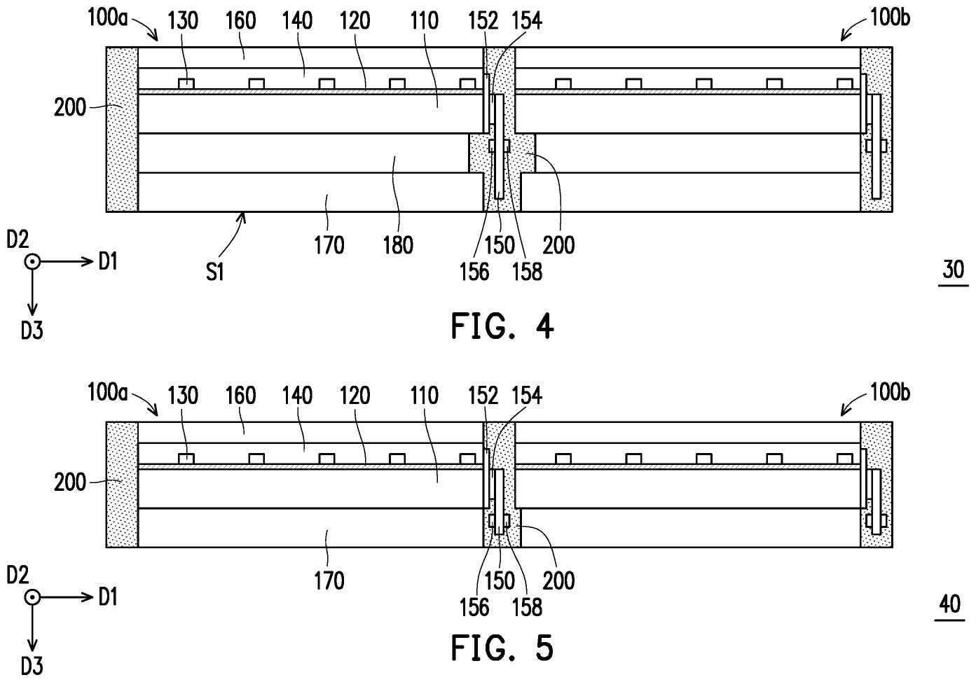

FIG. 4 is a cross-sectional view of the third embodiment according to section line A-A′ of FIG. 1. The difference between a tiled transparent display device 30 and the tiled transparent display device 20 is that the circuit board 150 may be extended to the transparent support substrate 170, that is, the circuit board 150 may be disposed between adjacent transparent support substrates 170. In some embodiments, the circuit board 150 may be not extended beyond a surface S1 of the transparent support substrate 170 away from the transparent substrate 110, but the disclosure is not limited thereto. In other embodiments (not shown), the circuit board 150 may be extended beyond the surface S1 of the transparent support substrate 170 away from the transparent substrate 110. At this time, the coupling member 200 may be extended beyond the surface Si of the transparent support substrate 170 away from the transparent substrate 110.

FIG. 5 is a cross-sectional view of the fourth embodiment according to section line A-A′ of FIG. 1. The difference between a tiled transparent display device 40 of the present embodiment and the tiled transparent display device 30 is that the tiled transparent display device 40 does not include the adhesive layer 180, that is, the transparent support substrate 170 is directly in contact with the transparent substrate 110. In some embodiments, in the third direction D3, the area of the transparent support substrate 170 and the area of the transparent substrate 110 may be the same or different. In some embodiments, the side surface of the transparent support substrate 170 and the side surface of the transparent substrate 110 may be substantially aligned or unaligned. In other embodiments (not shown), the conductive element 152 may be extended from the side surface of the transparent substrate 110 to the side surface of the transparent support substrate 170, and the conductive adhesive 154 may be in contact with the conductive element 152 disposed on the side surface of the transparent support substrate 170 and the side surface of the transparent substrate 110 to increase the contact area between the conductive element 152 and the conductive adhesive 154 and thereby improve the effect of signal transmission.

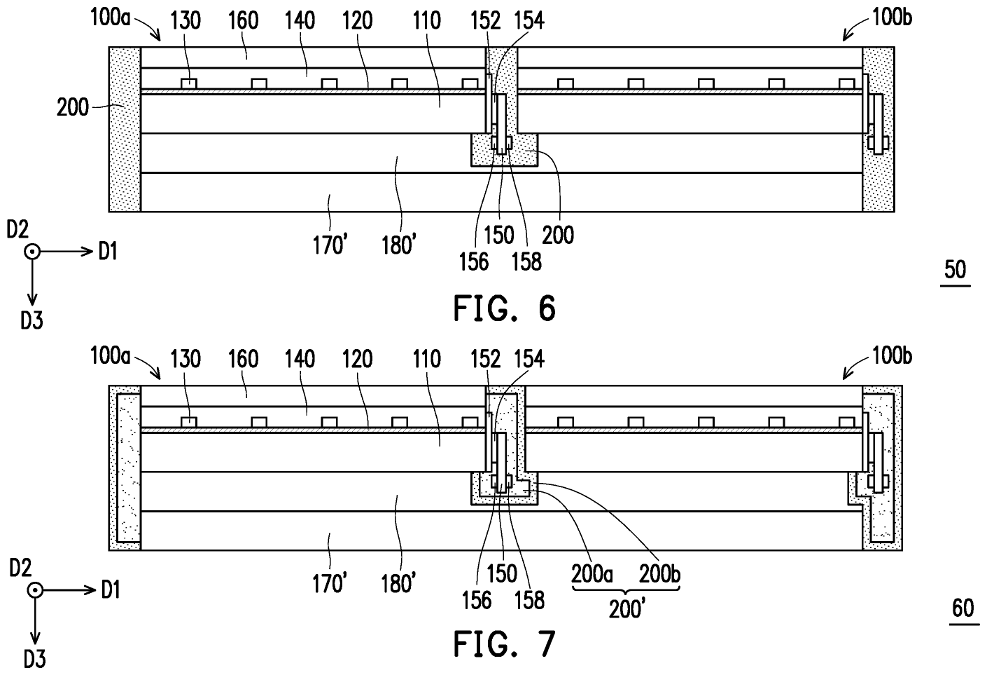

FIG. 6 is a cross-sectional view of the fifth embodiment according to section line A-A′ of FIG. 1. The difference between a tiled transparent display device 50 of the present embodiment and the tiled transparent display device 20 is that the first transparent display panel 100a and the second transparent display panel 100b share a transparent support substrate 170′ and/or an adhesive layer 180′. In some embodiments, in the third direction D3, the adhesive layer 180′ has a different thickness. For example, the thickness of the portion of the adhesive layer 180′ overlapped with the coupling member 200 is less than the thickness of the portion of the adhesive layer 180′ overlapped with the transparent substrate 110, but it is not limited thereto.

FIG. 7 is a cross-sectional view of the sixth embodiment according to section line A-A′ of FIG. 1. The difference between a tiled transparent display device 60 of the present embodiment and the tiled transparent display device 50 is that a coupling member 200′ has a plurality of layers of structures. In some embodiments, the coupling member 200′ may include a first portion 200a and a second portion 200b, but it is not limited thereto. In some embodiments, the first portion 200a may be in contact with or cover the circuit board 150. In some embodiments, the second portion 200b may be in contact with or cover the first portion 200a. In some embodiments, the material of the second portion 200b and/or the first portion 200a may include the same or similar material as the coupling member 200. In some embodiments, the transmittance and/or the reflectance of the second portion 200b may be the same as or similar to the transmittance and/or the reflectance of the coupling member 200, but the disclosure is not limited thereto. In some embodiments, the material of the first portion 200a may include an insulating material, a heat-resistant material, an adhesive material and/or a protective material, or a combination thereof, but it is not limited thereto.

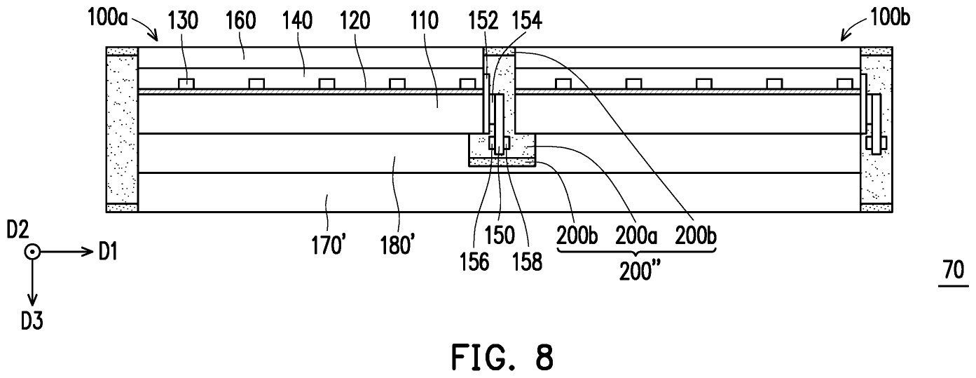

FIG. 8 is a cross-sectional view of the seventh embodiment according to section line A-A′ of FIG. 1. The difference between a tiled transparent display device 70 and the tiled transparent display device 60 is that a coupling member 200″ may include a first portion 200a and two second portions 200b. In some embodiments, the first portion 200a is at least in contact with or covers the circuit board 150, and the two second portions 200b may be disposed on two sides (the light incident side and the display side) of the first portion 200a, but it is not limited thereto. Similarly, the material of the second portion 200b may be the same as or similar to the coupling member 200. In other words, the transmittance and/or the reflectance of the second portion 200b may be the same as or similar to the coupling member 200, but the disclosure is not limited thereto. In addition, the material of the first portion 200a may be similar to the material of the first portion 200a of the embodiment shown in FIG. 7, for example, but it is not limited thereto.

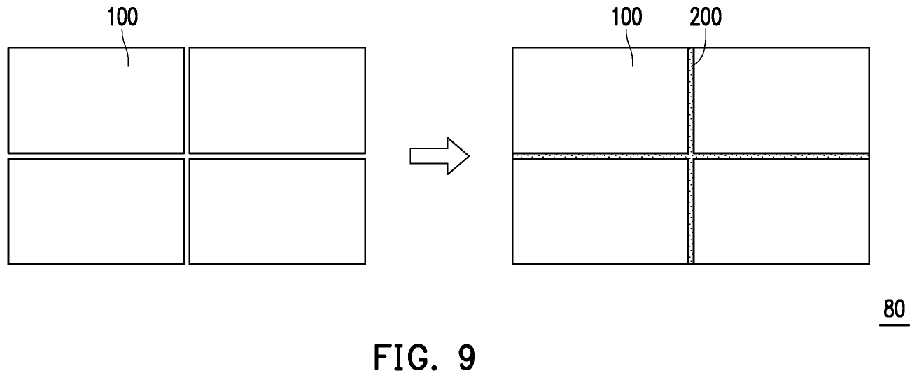

FIG. 9 is a diagram of a part of a manufacturing process of a tiled transparent display device of an embodiment of the disclosure.

Referring to FIG. 9, a tiled transparent display device 80 of the present embodiment may be formed through the following steps. First, a plurality of transparent display panels 100 for tiling are provided, and any transparent display panel 100 and an adjacent transparent display panel 100 may be arranged horizontally, vertically, or in other manners. In some embodiments, adjacent transparent display panels 100 are separated from each other. In other words, there is a gap between adjacent transparent display panels 100. Next, a material layer (not shown) of the coupling member is disposed in the gap or the material layer of the coupling member is disposed on at least one side surface of the transparent display panel 100, and then, for example, the material layer of the coupling member is cured to form the coupling member 200, but the disclosure is not limited thereto. In some embodiments, the reflectance (R_{c}) of the coupling member 200 and the transmittance (Tₚ) of the transparent display panel 100 satisfy the following relationship: 0.8 Tₚ≤R_{c}≤1.2 Tₚ. It should be noted that although FIG. 9 illustrates four transparent display panels 100, the number of the transparent display panels 100 for tiled is not limited.

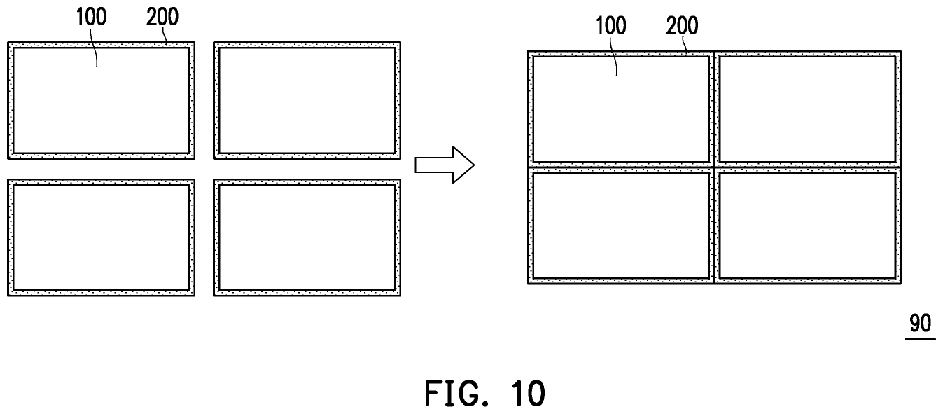

FIG. 10 is a diagram of a part of a manufacturing process of a tiled transparent display device of another embodiment of the disclosure. A tiled transparent display device 90 of the present embodiment may be formed through the following steps. First, a plurality of transparent display panels 100 for tiling are provided, and a material of the coupling member 200 is disposed on a side surface (for example, four side surfaces, but not limited thereto) of the transparent display panel 100, and the material of the coupling member 200 may be (pre-)cured to form the coupling member 200. Next, a plurality of transparent display panels 100 are spliced, and any one of the transparent display panels 100 and an adjacent transparent display panel 100 may be arranged horizontally, vertically or in other manners, and the coupling members 200 on the adjacent transparent display panels 100 may be in contact with each other, but the disclosure is not limited thereto. In other embodiments, a plurality of transparent display panels 100 may be fixed by using a frame (not shown) additionally. It should be noted that although FIG. 10 illustrates four transparent display panels 100, the number of the transparent display panels 100 for tiled is not limited.

According to the above, the flexible display device of an embodiment of the disclosure enables the reflectance of the coupling member, the transmittance of the first transparent display panel, and the transmittance of the second transparent display panel to satisfy the above relationship. Therefore, it is difficult for a viewer to observe the presence of the tiled stitching pattern (or coupling member) when viewing the screen displayed by the tiled transparent display device, thus improving display quality.

Lastly, it should be noted that the above embodiments are used to describe the technical solution of the disclosure instead of limiting it. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure. As long as the features between the embodiments do not violate the spirit of the disclosure or conflict, they may be mixed and used arbitrarily.

What is claimed is:

1. A tiled transparent display device, comprising:
a first transparent display panel;
a second transparent display panel adjacent to the first transparent display panel; and
a coupling member disposed between the first transparent display panel and the second transparent display panel,
wherein a reflectance (R_{c}) of the coupling member, a transmittance (Tₚ₁) of the first transparent display panel, and a transmittance (Tₚ₂) of the second transparent display panel satisfy the following relationship:
0.8 Tₚ₁≤R_{c}≤1.2 Tₚ₁, and 0.8 Tₚ₂≤R_{c}≤1.2 Tₚ₂.

2. The tiled transparent display device of claim 1, wherein the reflectance (R_{c}) of the coupling member, the transmittance (Tₚ₁) of the first transparent display panel, and the transmittance (Tₚ₂) of the second transparent display panel satisfy the following relationship:
0.95 Tₚ₁≤R_{c}≤1.05 Tₚ₁, and 0.95 Tₚ₂≤R_{c}≤1.05 Tₚ₂.

3. The tiled transparent display device of claim 1, wherein a transmittance of the coupling member is greater than 0 and less than 0.1.

4. A transparent display device for tiling with another transparent display device, comprising:
a transparent display panel; and
a coupling member disposed on at least one side of the transparent display panel,
wherein a reflectance (R_{c}) of the coupling member and a transmittance (Tₚ) of the transparent display panel satisfy the following relationship:
0.8 Tₚ≤R_{c}≤1.2 Tₚ.

5. The transparent display device of claim 4, wherein the reflectance (R_{c}) of the coupling member and the transmittance (Tₚ) of the transparent display panel satisfy the following relationship:
0.95 Tₚ≤R_{c}<1.05 Tₚ.

6. The transparent display device of claim 4, wherein a transmittance of the coupling member is greater than 0 and less than 0.1.
